(19) United States
(12) Patent Application Publication
(10) Pub. No.: US 2025/0033871 A1
(43) Pub. Date: Jan. 30, 2025

(54) THERMO-HYGROSTAT INSTALLED IN CONTAINER FOR ENERGY STORAGE

(71) Applicant: Chung Lock OH, Gwangju (KR)

(72) Inventor: Chung Lock OH, Gwangju (KR)

(21) Appl. No.: 18/372,151

(22) Filed: Sep. 25, 2023

(30) Foreign Application Priority Data
Jul. 27, 2023 (KR) 10-2023-0097970

(51) Int. Cl. B65D 88/74

(52) U.S. Cl. CPC B65D 88/745; B65D 88/747

(57) ABSTRACT

The present disclosure relates to a thermo-hygrostat provided in an ESS container that stores and uses energy using a battery, and more particularly, a thermo-hygrostat installed in the accommodation opening formed on one side of the container, being movable inward and outward, not protruding outside the container during transportation of the container, and protruding to the outside of the container, after installing the container, to form a cooling passage through which air can circulate inside the container, thereby efficiently utilizing space inside the container even when its volume increases as the capacity of the thermo-hygrostat increases.

### CROSS-REFERENCE TO RELATED APPLICATION(S)

This application claims priority to Korean Patent Application No. 10-2023-0097970 filed in the Korean Intellectual Property Office on Jul. 27, 2023, the disclosure of which is incorporated by reference herein in its entirety.

### TECHNICAL FIELD

The present disclosure relates to a thermo-hygrostat provided in a container that stores and uses energy using a battery, and more particularly, a thermo-hygrostat installed in the accommodation opening formed on one side of the container, being movable inward and outward, not protruding outside the container during transportation of the container, and protruding to the outside of the container, after installing the container, to form a cooling passage through which air can circulate inside the container, thereby efficiently utilizing space inside the container even when its volume increases as the capacity of the thermo-hygrostat increases.

### DISCUSSION OF RELATED ART

As the depletion of petroleum resources and the dangers of nuclear energy are highlighted, interest in and research on new and renewable energy is significantly increasing. In addition, it is essential to develop an energy storage system (ESS) for using renewable energy such as solar power generation and wind power generation.

ESS stands for “Energy Storage System” and means a system that stores energy. ESS is a system that stores energy generated in the power grid and can extract and use it later when needed. ESS has the advantage of improving the stability of power supply and efficiently integrating renewable energy.

ESS can be implemented in various forms, one of which is an ESS container equipped with a storage unit (for example, a battery) for storing energy inside the container. These ESS containers have the advantage of being easy to move and transport and easy to install.

Meanwhile, ESS is installed in an enclosed installation space for efficient power storage or power supply inside a container, and the installation space is maintained within a set temperature and humidity range. When the temperature of the installation space exceeds the set temperature, the ESS overheats, but when it falls below the set temperature, the power storage efficiency decreases.

Korea Patent Registration No. 10-0939281 discloses an energy-saving thermo-hygrostat using outside air introduction and its control method. The above patent discloses the technology in which when the outside temperature is lower than the temperature of the installation space where the computer system or electronic product manufacturing equipment is installed, cold air from the outside is introduced into the installation space to lower the temperature of the installation space, but when the outside temperature is higher than the temperature of the installation space, the cold air generated from the evaporator of the refrigeration cycle system provided in the installation space is circulated into the installation space to lower the temperature of the installation space.

As such, it is important to control the temperature and humidity inside the container so that the ESS operates smoothly and efficiently. When the calorific value of ESS increases, the capacity of the thermo-hygrostat must be increased to cool it.

However, within the limited space of the container, the ESS that stores and outputs power occupies most of the space, and accordingly, the volume of the thermo-hygrostat cannot be increased indefinitely. When the volume of the thermo-hygrostat increases, the volume of the ESS must be relatively reduced, which leads to a decrease in power storage capacity.

Further, the cooling air discharged from the thermo-hygrostat must be properly separated from the batteries in the ESS to cool all batteries smoothly. Therefore, the distance between ESSs must be spaced at a certain level. As the spacing distance between the thermo-hygrostat and the ESS must be secured, the volume of the thermo-hygrostat is further restricted.

Therefore, it is necessary to develop a thermo-hygrostat capable of efficiently cooling the battery of the ESS while increasing the capacity of the thermo-hygrostat installed in the ESS container.

### SUMMARY

An An object of the present disclosure is to provide a thermo-hygrostat provided in a container for energy storage in which an accommodation opening of a certain size is formed on one side of the container in which the ESS is mounted, a thermo-hygrostat is installed in the accommodation opening, and the thermo-hygrostat can move inside and outside the container through the accommodation opening, thereby expanding the cooling passage for cooling the ESS battery inside the container to improve the cooling efficiency.

Another object of the present disclosure is to provide a thermo-hygrostat provided in a container for energy storage in which when transporting and conveying an energy storage container, the thermo-hygrostat is inserted into the container to prevent it from protruding out of the container, it can be safely transported while complying with the standards set for transport and convey, and after installing the energy storage container, the thermo-hygrostat protrudes out of the container to drastically reduce the space occupied inside the container, thereby efficiently utilizing the space inside the container.

Still another object of the present disclosure is to provide a thermo-hygrostat provided in a container for energy storage in which the packing is arranged along the edge of the container, to draw or insert the thermo-hygrostat from the container and prevent the inflow of rainwater and foreign substances into the container at the same time to protect the ESS.

Yet another object of the present disclosure is to provide a thermo-hygrostat provided in a container for energy storage in which the first bracket coupled to the side wall of the container and an adjustment bolt passing through the first bracket coupled to both sides of the thermo-hygrostat are provided. and the thermo-hygrostat can be moved inward and outward of the container by forward and reverse rotation of the adjustment bolt.

Further another object of the present disclosure is to provide a thermo-hygrostat provided in a container for energy storage in which both ends of the fixing base come into contact with the first bracket and the second bracket while the fixing base surrounds the body part of the adjustment bolt penetrating both the first and second brackets, thereby preventing the thermo-hygrostat from being drawn out due to the rotation of the adjustment bolt by vibration during transport and convey.

The present disclosure provides a thermo-hygrostat 300 provided in the energy storage container, wherein the thermo-hygrostat 300 stores energy and controls the temperature and humidity of a container 100 in which an energy storage system (ESS) is installed, an accommodation opening 110 having the size of the thermo-hygrostat 300 is formed on one side of the container 100 in which the ESS is installed, the thermo-hygrostat 300 is mounted on the accommodation opening 110 so that the outer surface 330 of the thermo-hygrostat 300 is always exposed to the outside of the container 100, and the thermo-hygrostat 300 slides inside or outside the container 100 through accommodation opening 110 and the position thereof is varied, and the position of the thermo-hygrostat 300 during operation protrudes outward of the container 100 more than the position of the thermo-hygrostat 300 during transport of the container 100.

The present disclosure further comprises a packing 111 which is provided at an edge of the accommodation opening 110 to contact both side surfaces 340 of the thermo-hygrostat 300 whose position is variably moved and fills a gap between the edge of the accommodation opening 110 and both side surfaces 340.

Further, the thermo-hygrostat 300 is disposed inside the container 100 during transport of the container 100 so that a side wall 130 of the container 100 and an outer surface 330 of the thermo-hygrostat 300 are on the same plane. and both side surfaces 340 and an inner surface 320 of the thermo-hygrostat 300 are disposed inside the container 100, and the thermo-hygrostat 300 moves to the outside of the container 100 during operation so that an outer surface 330 of the thermo-hygrostat 300 protrudes outward from a side wall 130 of the container 100, thereby widening a cooling passage d, which is the space between an inner surface 320 of the thermo-hygrostat 320 and a battery 200 of the ESS disposed inside the container 100.

Further, the thermo-hygrostat comprises a first bracket 120 coupled to the side wall 130 of the container 100 and having a first bolt hole 121 formed on one side thereof, a second bracket 130 coupled to one of both side surface 340 of the thermo-hygrostat 300 and having a second bolt hole 311 formed on one side thereof, the second bolt hole 311 facing the first bolt hole 121, and an adjustment bolt 400 passing through both the first bolt hole 121 and the second bolt hole 311, allowing a head part 410 to be in surface contact with the first bracket 120, and adjusting a distance of the cooling passage d while rotating forward and backward.

Further, the thermo-hygrostat 300 is drawn out of the container 100 during forward-rotation of the adjustment bolt 400 so that the volume V1 occupied by the thermo-hygrostat 300 inside the container 100 decreases but the volume V2 occupied by the thermo-hygrostat 300 outside the container 100 increases, and when the thermo-hygrostat 300 is maximally drawn out, the second bracket 310 contacts the first bracket 120, and the volume V1 occupied by the thermo-hygrostat 300 inside the container 100 is minimized to maximize the distance of the cooling passage d.

Further, the thermo-hygrostat 300 enters the inside of the container 100 during reverse-rotation of the adjustment bolt 400 so that the volume V1 occupied by the thermo-hygrostat 300 inside the container 100 increases but the volume V2 occupied by the thermo-hygrostat 300 outside the container 100 decreases, and when the thermo-hygrostat 300 maximally enters the inside, an outer surface 330 of the thermo-hygrostat 300 and the side wall 130 of the container 100 lie on the same plane, and the volume V2 occupied by the thermo-hygrostat 300 outside the container 100 becomes 0.

The present disclosure further comprises a fixture base 430 formed in a cylindrical shape with a hollow center, having a slit 431 through which the body part 420 of the adjustment bolt 400 passes is formed on the side surface, and having both ends in contact with the first bracket 120 and the second bracket 310 while surrounding the body part 420 of the adjustment bolt 400.

The present disclosure further comprises a rail provided on the side or bottom side of the thermo-hygrostat 300 and guiding the movement of the thermo-hygrostat 300 by forward and reverse rotation of the adjustment bolt 400.

Further, the cooling passage d when the thermo-hygrostat 300 is operating is longer than the cooling passage d when the container 100 is transferred.

The present disclosure provides a thermo-hygrostat provided in a container for energy storage in which an accommodation opening of a certain size is formed on one side of the container in which the ESS is mounted, a thermo-hygrostat is installed in the accommodation opening, and the thermo-hygrostat can move inside and outside the container through the accommodation opening, thereby expanding the cooling passage for cooling the ESS battery inside the container to improve the cooling efficiency.

The present disclosure provides a thermo-hygrostat provided in a container for energy storage in which when transporting and conveying an energy storage container, the thermo-hygrostat is inserted into the container to prevent it from protruding out of the container, it can be safely transported while complying with the standards set for transport and convey, and after installing the energy storage container, the thermo-hygrostat protrudes out of the container to drastically reduce the space occupied inside the container, thereby efficiently utilizing the space inside the container.

The present disclosure provides a thermo-hygrostat provided in a container for energy storage in which the packing is arranged along the edge of the container, to draw or insert the thermo-hygrostat from the container and prevent the inflow of rainwater and foreign substances into the container at the same time to protect the ESS.

The present disclosure provides a thermo-hygrostat provided in a container for energy storage in which the first bracket coupled to the side wall of the container and an adjustment bolt passing through the first bracket coupled to both sides of the thermo-hygrostat are provided, and the thermo-hygrostat can be moved inward and outward of the container by forward and reverse rotation of the adjustment bolt.

The present disclosure provides a thermo-hygrostat provided in a container for energy storage in which both ends of the fixture come into contact with the first bracket and the second bracket while the fixture surrounds the body part of the adjustment bolt penetrating both the first and second brackets, thereby preventing the thermo-hygrostat from being drawn out due to the rotation of the adjustment bolt by vibration during transport and convey.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 shows an overall perspective view of the thermo-hygrostat provided in an energy storage container according to the present disclosure;

FIG. 2 shows an exploded perspective view of the thermo-hygrostat provided in an energy storage container according to the present disclosure;

FIG. 3 shows a plan sectional view of the thermo-hygrostat provided in an energy storage container according to the present disclosure;

FIG. 4 shows a cross-sectional side view of the thermo-hygrostat provided in an energy storage container according to the present disclosure;

FIG. 5 shows the first bracket, the second bracket, and the adjustment bolt for moving the thermo-hygrostat in the thermo-hygrostat provided in the container for energy storage according to the present disclosure, (a) is an overall perspective view, and (b) is a partial perspective view;

FIG. 6 shows a state in which the thermo-hygrostat maximally moves outward from the container, when the thermo-hygrostat is operated, for the thermo-hygrostat provided in the container for energy storage according to the present disclosure, (a) is a perspective view, and (b) is a plan view;

FIG. 7 shows a state in which the thermo-hygrostat maximally moves inward from the container, when the container is transferred, for the thermo-hygrostat provided in the container for energy storage according to the present disclosure, (a) is a perspective view, and (b) is a plan view;

FIG. 8 shows a perspective view showing a form in which the thermo-hygrostat is installed on the door of the container in the thermo-hygrostat provided in the container for energy storage according to another embodiment of the present disclosure;

FIG. 9 shows a state when the thermo-hygrostat is in operation for the thermo-hygrostat provided in a container for energy storage according to another embodiment of the present disclosure, (a) is a perspective view, and (b) is a plan view; and

FIG. 10 shows a state when the container is transferred for the thermo-hygrostat provided in a container for energy storage according to another embodiment of the present disclosure, (a) is a perspective view, and (b) is a plan view.

### DETAILED DESCRIPTION OF EXEMPLARY EMBODIMENTS

Hereinafter, a preferred embodiment of the present disclosure is described with reference to the accompanying drawings so that those skilled in the art can easily implement it.

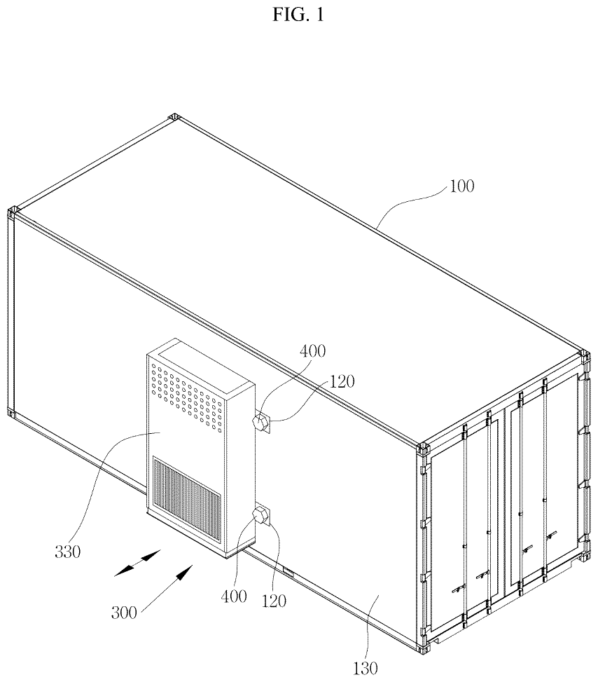

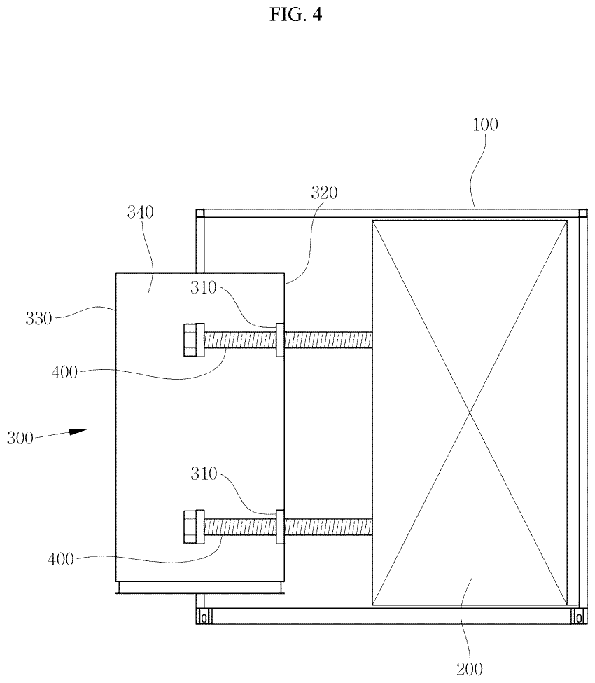

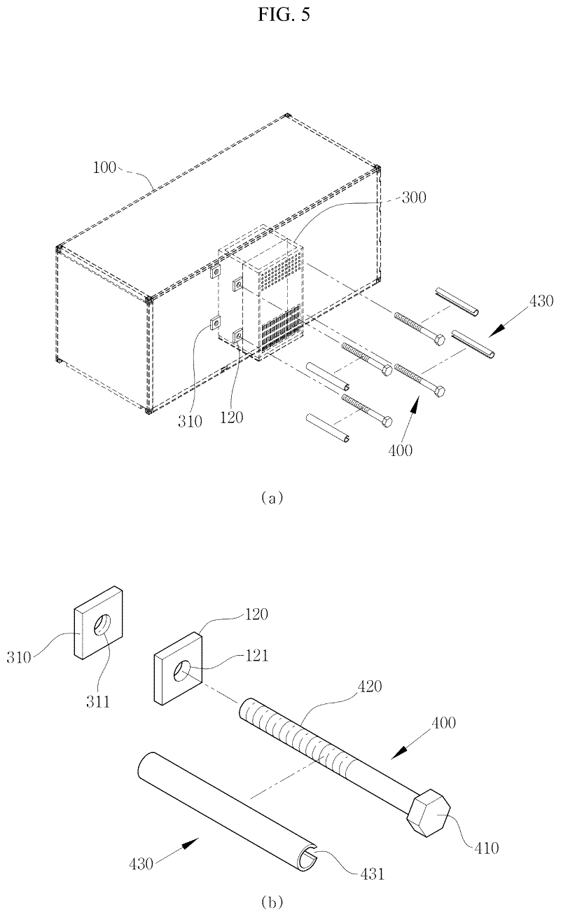

As shown in FIGS. 1 to 7, the thermo-hygrostat provided in the energy storage container according to the present disclosure is a device for maintaining constant temperature and humidity inside the container 100 to protect and cool the ESS battery 200, and the present disclosure provides the thermo-hygrostat 300 provided in the energy storage container, wherein the thermo-hygrostat 300 stores energy and controls the temperature and humidity of the container 100 in which ESS is installed, the accommodation opening 110 having the size of the thermo-hygrostat 300 is formed on one side of the container 100 in which the ESS is installed, the thermo-hygrostat 300 is mounted on the accommodation opening 110 so that the outer surface 330 of the thermo-hygrostat 300 is always exposed to the outside of the container 100, and the thermo-hygrostat 300 slides inside or outside the container 100 through accommodation opening 110 and the position thereof is varied, and the position of the thermo-hygrostat 300 during operation protrudes outward of the container 100 more than the position of the thermo-hygrostat 300 during transport of the container 100.

ESS, an abbreviation of Energy Storage System, is a system equipped to store energy inside the system and use it when needed. Although the ESS may store various types of energy, an embodiment of the present disclosure is described using the battery 200 to store and use electrical energy as an example.

The ESS stores energy that is overproduced during times of low demand in the power grid, and then supplies the energy stored in the ESS during times when power demand is soaring that it is difficult to cope with only the supply amount in the power grid, thereby making up for the insufficient power grid supply.

Further, renewable energy, such as solar and wind power, which is greatly affected by the natural environment, can be stored in the ESS in advance and used at the required time. Therefore, energy produced from the renewable power grid can be used more freely.

In order to transport and install such an ESS more easily and conveniently, an ESS facility is provided inside the container 100 and provided in a modular form. Such a container 100 for energy storage has the advantage of being easily transportable and conveyable with the advantage of convenient mobility.

As the ESS inside the container 100 generates heat during use after installation, the temperature inside the container 100 rises. High temperature and humidity adversely affect ESS. Therefore, a device for cooling it is required. The thermo-hygrostat 300 is installed inside the container 100 to control the temperature and humidity inside the container 100, thereby forming an air conditioning system in which the ESS can operate more smoothly. The thermo-hygrostat 300 is disposed inside the container 100 to cool the ESS inside the container 100, and it is preferable to have a cooling capacity capable of sufficiently cooling the amount of heat generated in the ESS. In general, when the cooling capacity is increased, the volume of the thermo-hygrostat 300 also increases.

However, for efficient handling in various transportation means such as ships and trucks and logistics systems, the size of the container 100 is formed according to the standards defined by an international standardization organization (ISO). In the limited internal space of the container 100, the volume of the thermo-hygrostat 300 cannot be increased indefinitely to increase the cooling capacity. In order to store and process a large amount of energy, the ESS occupies a space inside the container 100 above a certain level. In order for the thermo-hygrostat 300 to efficiently cool the entire area rather than a local area of the ESS, space between ESS facilities must be formed to generate a cooling passage d, so the volume of the thermo-hygrostat 300 is limited.

The present disclosure is to address the issues caused by the increase in the volume of the thermo-hygrostat 300 mounted inside the energy storage container 100, the accommodation opening 110 corresponding to the size of the thermo-hygrostat 300 is formed on one side of the container 100, the thermo-hygrostat 300 is inserted into the accommodation opening 110, and the thermo-hygrostat 300 is provided to slide in the accommodation opening 110. As the thermo-hygrostat 300 moves inward and outward from the container 100, the space (volume) occupied by the thermo-hygrostat 300 inside the container 100 may vary.

When the container 100 for energy storage is transported and conveyed, the ESS facility does not operate so that it does not generate heat and thus does not need to be cooled. Therefore, the thermo-hygrostat 300 is not operated and is inserted into the container 100 so that it does not protrude outside the container 100. As a result, there is no jamming in transportation and convey, so there is little risk of damage.

After completing the transport and convey of the energy storage container 100 and installing it, when the ESS starts to operate, heat is generated in the ESS and must be cooled. For effective cooling, the thermo-hygrostat 300 is slightly pulled out of the container 100 to form a cooling passage d, which is a space between the ESS facility and the thermo-hygrostat 300. At this time, a part of the thermo-hygrostat 300 protrudes to the outside of the container 100, but since the container 100 is fixed and installed in one place, there is no concern about jamming or damage.

As such, even if the volume increases to increase the cooling capacity of the thermo-hygrostat 300, when operating after installation of the energy storage container 100, the cooling passage d can be secured by slightly withdrawing the thermo-hygrostat 300 out of the container 100, and when transporting and conveying the container 100, the thermo-hygrostat 300 is inserted into the container 100 so as not to protrude outside the container 100 to provide convenient mobility.

Therefore, the thermo-hygrostat provided in the container for energy storage according to the present disclosure has the advantage of effectively cooling the entire area of the ESS facility inside the container 100 while having a larger cooling capacity.

As shown in FIGS. 1 to 3, the ESS facility according to the present disclosure is provided in the container 100 to easily transport and install related facilities. Such a container 100 is referred to as an energy storage container 100 or simply a container 100. The facilities constituting the ESS include various components that function as energy storage, output, and control, but only the battery 200 occupying a large volume is shown in the drawing according to an embodiment of the present disclosure. However, it does not mean that other components constituting the ESS are excluded, and illustration is excluded. The container 100 may be transported overseas using a ship.

Referring to FIG. 1, in the present disclosure, an inward direction means a direction toward the center of the container 100, and an outward direction means a direction toward the outside of the container 100 opposite to the inward direction.

As shown in the figure, when the energy storage container 100 of the present disclosure is transported and transferred, the thermo-hygrostat 300 slides inward of the container 100 and does not protrude to the outside. When the transfer and transportation of the container 100 for energy storage is completed, and when it is installed and operated, the thermo-hygrostat 300 slides outward of the container 100 so that part or all of the thermo-hygrostat 300 protrudes outside of the container 100, that is, outward from the outer surface 330 of the container 100.

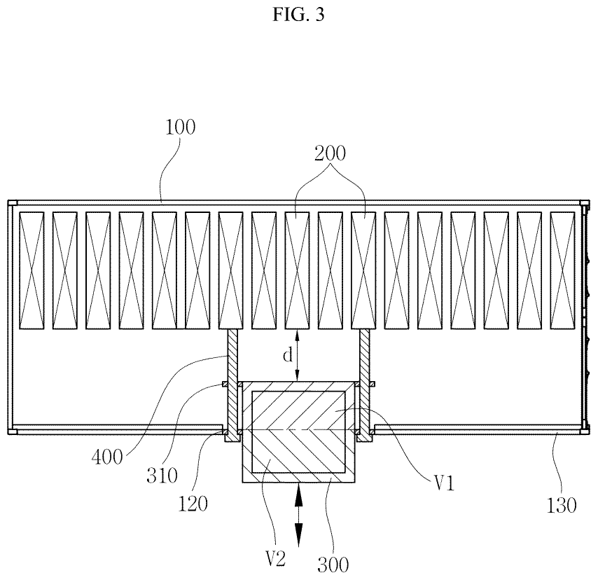

Referring to FIG. 3, the container 100 may be formed in various standard sizes. A battery 200, which is one of the ESS facilities, is placed inside the container 100 manufactured to these standards. In the present disclosure, the battery 200 is referred to by including various types of batteries 200 such as cells, modules, and packs, and is simply referred to as “battery” 200 for convenience of description.

The battery 200 according to an embodiment of the present disclosure is provided and arranged in plurality, but the arrangement direction is the longitudinal direction of the container 100. At this time, the longitudinal direction means the direction of the corner that is 6.058 m in the 20-foot Standard Container defined by ISO.

There is a slight gap between the batteries 200 for cooling, and the spaced gap becomes a passage through which cooling air flows into the batteries 200 and heated air is discharged from the batteries 200.

The side wall 130 of the container 100 refers to a wall that divides the inside and outside of the container 100.

In the present disclosure, the movement of the container 100 for the purpose of transport is expressed as ‘transfer,’ and the movement of the thermo-hygrostat 300 relative to the container 110 is expressed as ‘sliding movement’ or ‘moving.’ When the container 100 is ‘transported,’ the thermo-hygrostat 300 is also transported along with the container 100 but does not move with respect to the accommodation opening 110, so it is not ‘(sliding) moved.’

In addition, supplying power to the ESS and operating it was expressed as ‘work’, and operation of the thermo-hygrostat 300 for cooling or dehumidification was expressed as ‘operation.’ ‘When the thermo-hygrostat 300 is in operation’ also includes the meaning of ‘when the container 100 is transported to a site and installed on the site.’

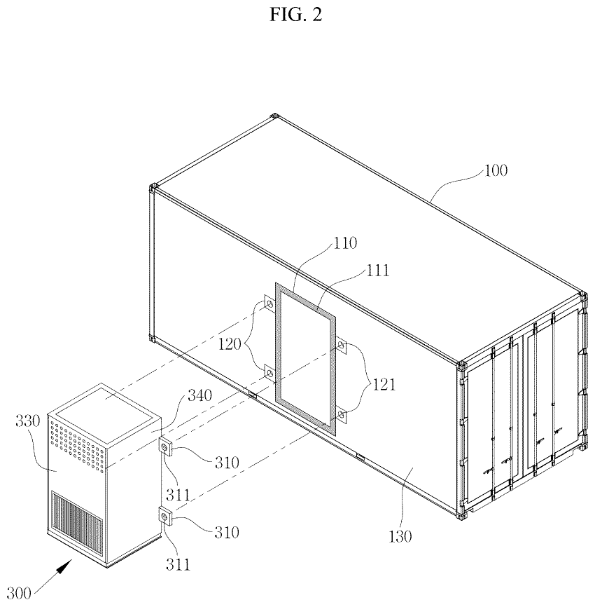

As shown in FIG. 2, the accommodation opening 110 corresponding to the size of the thermo-hygrostat 300 is formed on one side of the container 100. The accommodation opening 110 is a passage through which the thermo-hygrostat 300 moves inward and outward of the container 100.

The packing 111 is provided at the edge of the container 110 to prevent water, foreign substances, etc. from entering the container 100 through a gap between the side surfaces 340 of the thermo-hygrostat 300. The packing 111 fills the gap between the edge of the container 110 and both side surfaces 340 of the thermo-hygrostat 300, prevents the cold air inside the container 100 from leaking out, and blocks rainwater, foreign substances, etc. outside the container 100 from entering the inside of the container 100.

The thermo-hygrostat 300 is variably moved inward and outward of the container 100, and both side surfaces 340 slide in contact with the packing 111, and no gap occurs between both side surfaces 340 of the thermo-hygrostat 300 and the packing 111.

Referring to FIG. 2, the thermo-hygrostat 300 inserted into the accommodation opening 110 is an air conditioner that controls the temperature and humidity inside the container 100 within a range in which the ESS may operate smoothly. Although the thermo-hygrostat 300 according to an embodiment of the present disclosure is illustrated as having a hexahedral outer surface, it may also be formed in various shapes.

In the thermo-hygrostat 300, the surface facing the container 100 is referred to as the inner surface 320, the surface facing the outside is referred to as the outer surface 330, and the left and right surfaces are referred to as both side surfaces 340. Both side surfaces 340 are surfaces in contact with the packing 111 inserted into the accommodation opening 110 and are left and right surfaces when the outer surface 330 is viewed from the front.

The thermo-hygrostat 300 has an entrance through which indoor and outdoor air of the container 100 enters and exits, and an outlet for discharging cold air from the thermo-hygrostat 300 is formed on the inner surface 320. The outlet of the inner surface 320 supplies cool air toward the ESS battery 200 to suppress heat generation of the ESS.

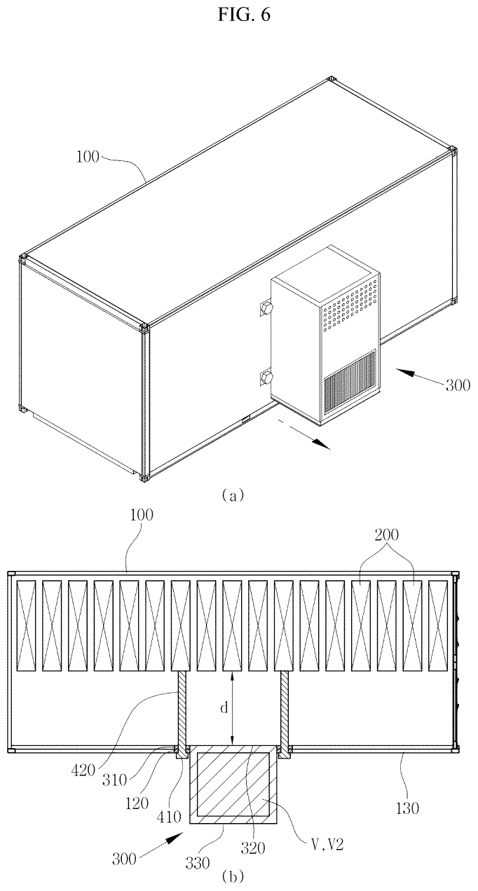

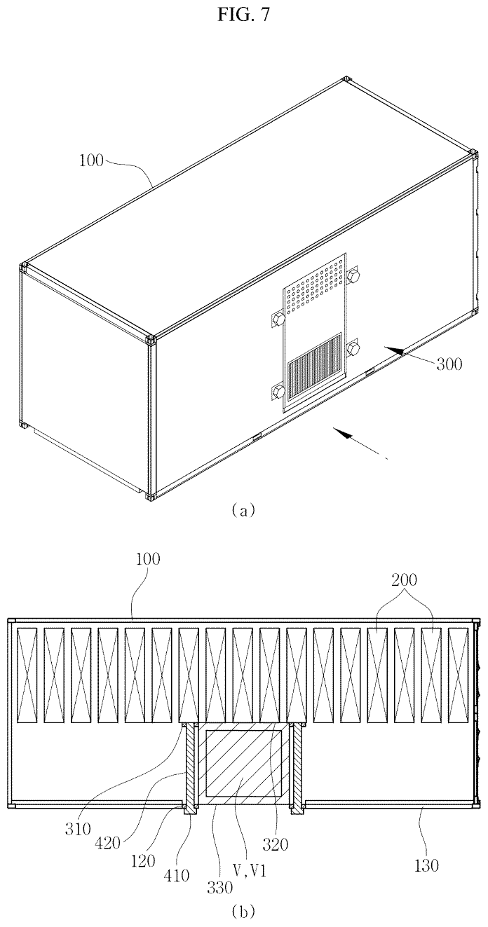

An outlet for discharging hot air to the outside of the container 100 may be formed on the outer surface 330. Regardless of whether the thermo-hygrostat 300 moves inward or outward, the outer surface 330 is always exposed to the outside of the container 100. It is obvious that the outer surface 330 is exposed when the thermo-hygrostat 300 moves outward, as shown in FIGS. 1 and 6. Even when the thermo-hygrostat 300 moves completely inward, the outer surface 330 is exposed to the outside as shown in FIG. 7.

The position of the thermo-hygrostat 300 may be changed by sliding inward or outward.

Depending on whether the container 100 for energy storage is transported and installed, the position of the thermo-hygrostat 300 is variously arranged within the container 100.

In the process of transporting and conveying the energy storage container 100, the thermo-hygrostat 300 moves inward the container 100, and the outer surface 330 does not protrude further than the side wall 130 of the container 100, more preferably, the outer surface 330 of the thermo-hygrostat 300 and the side wall 130 of the container 100 are placed on the same plane as shown in FIG. 7. At this time, in order to increase the cooling capacity of the thermo-hygrostat 300, the inner surface 320 is preferably in contact with the battery 200 because the volume can increase so that there is no cooling passage d, but the cooling passage d may be formed at a minimum level. In the present disclosure, when the container 100 is transported, it is assumed that the position of the thermo-hygrostat 300 is completely moved inward as shown in FIG. 7.

After completing the transfer and transportation of the energy storage container 100 and installing it, the thermo-hygrostat 300 is slid so that the outer surface 330 of the thermo-hygrostat 300 protrudes outward more than the side wall 130 of the container 100. In the present disclosure, when operating the thermo-hygrostat 300, the installation of the container 100 is completed, The thermo-hygrostat 300 slides outwardly of the container 100 so that the outer surface 330 of the thermo-hygrostat 300 protrudes more than the side wall 130, as shown in FIG. 1 or 7. The maximum protruding length of the cooling passage d maximizes the cooling efficiency, but it may vary depending on the environment and conditions.

Therefore, when the thermo-hygrostat 300 is in operation, since the container 100 is not being transported but the installation is completed, the position of the thermo-hygrostat 300 protrudes outward from the container 100 more than the position of the thermo-hygrostat 300 when the container 100 is transported.

For convenience of explanation, as shown in FIGS. 3, 6 and 7, the volume of the thermo-hygrostat 300 is referred to as ‘V.’ The volume occupied by the thermo-hygrostat 300 in the inner space of the container 100 is referred to as ‘V1.’ and the volume occupied in the outer space of the container 100 is referred to as ‘V2.’ When the thickness of the container 100 is excluded, the sum of the volume V1 occupied in the inner space of the container 100 and the volume V2 occupied in the outer space of the container 100 is equal to the volume V of the thermo-hygrostat 300.

The present disclosure increases the volume V of the thermo-hygrostat 300 as much as possible to increase the cooling capacity but minimizes the volume V1 occupied by the thermo-hygrostat 300 inside the container 100, so that the large-capacity battery 200 is installed inside the container 100, and further the cooling passage d is formed so that the battery 200 can be effectively cooled.

To this end, the thermo-hygrostat 300 slides inward and outward the container 100 through the accommodation opening 110, rather than being fixed inside the container 100 so that the volume V1 occupied inside the container 100 is minimized.

To complete the installation of the container 100 and operate the thermo-hygrostat 300, when the thermo-hygrostat 300 slides outwardly of the container 100, the cooling passage d, which is a space in which the inner surface 320 of the thermo-hygrostat 300 and the battery 200 are separated, widens. When the battery 200 is too close to the inner surface 320, which is the surface through which cold air is discharged from the thermo-hygrostat 300, it becomes difficult for the cold air to diffuse to the entire area of the ESS, and the cold air reaches only the local area adjacent to the inner surface 320, so that the ESS in the area where cold air does not reach is not cooled, causing a concern of failure.

Therefore, while the thermo-hygrostat 300 slides (withdraws) to the outside, it is spaced between the inner surface 320 through which cold air is discharged and the battery 200, and the cooling passage d is sufficiently secured, so that cold air is diffused to the entire area of the ESS, thereby effectively cooling the ESS.

As the thermo-hygrostat 300 moves inward and outward of the container 100, the space of the cooling passage d increases or decreases. Even if the volume of the thermo-hygrostat 300 increases (cooling capacity increases) so that the spacing distance (cooling passage d) between the inner surface 320 of the thermo-hygrostat 300 and the battery 200 converges to 0, the thermo-hygrostat 300 is drawn to secure the cooling passage d.

For cooling of the ESS facility, a space between the batteries 200 and a space between the battery 200 and the side wall 130 of the container 100 must also be secured. In the present disclosure, it is assumed that the space between the batteries 200 and the separation space between the side wall 130 of the container 100 and the battery 200 are secured, and the cooling passage (d) is used to mean a separation space between the inner surface 320 and the battery 200.

As shown in FIGS. 2, 3, 4, and 5, to more smoothly slide the thermo-hygrostat 300 in the accommodation opening 110, the first bracket 120, the second bracket 310, and the adjustment bolt 400 are provided. The first bracket 120, the second bracket 310, and the adjustment bolt 400 are provided in plural numbers and can be disposed at various locations.

The first bracket 120 is a bracket coupled to the side wall 130 of the container 100, and a first bolt hole 121 is formed on one side. The second bracket 310 may be a bracket coupled to both side surfaces 340 of the thermo-hygrostat 300 or may be coupled to other surfaces other than both side surfaces 340. A second bolt hole 311 is formed on one side of the second bracket 310. The first bolt hole 121 and the second bolt hole 311 are disposed to face each other, and the adjustment bolt 400 passes through both the first bolt hole 121 and the second bolt hole 311.

The head part 410 of the adjustment bolt 400 is formed larger than the first bolt hole 121 and the second bolt hole 311 so that it does not penetrate the bolts, but the body part 420 passes through the first bolt hole 121 and the second bolt hole 311.

The adjustment bolt 400 is fixed to either one of the first bracket 120 and the second bracket 310, and any one of the brackets not fixed to the adjustment bolt 400 moves in the longitudinal direction of the adjustment bolt 400 according to forward and reverse rotation of the adjustment bolt 400.

The first bracket 120 is coupled to the container 100 and the second bracket 310 is coupled to the thermo-hygrostat 300, so that the thermo-hygrostat 300 slides along the accommodation opening 110 of the container 100 according to the forward and reverse rotation of the adjustment bolt 400.

In one embodiment of the present disclosure, the head part 410 of the adjustment bolt 400 comes into surface contact with the first bracket 120 and is rotatably fixed with the first bracket 120. As the adjustment bolt 400 rotates, the second bolt hole 311 of the second bracket 310 moves along the thread of the adjustment bolt 400, and the thermo-hygrostat 300 slides to adjust he distance of the cooling passage d.

When the forward rotation of the adjustment bolt 400 moves the thermo-hygrostat 300 outward, the volume V1 occupied by the thermo-hygrostat 300 in the inner space of the container 100 gradually decreases, but the volume V2 occupied by the thermo-hygrostat 300 in the outer space of the container 100 increases. When the volume V2 occupied by the thermo-hygrostat 300 is maximized in the outer space of the container 100, both side surfaces 340 and the inner surface 320 of the thermo-hygrostat 300 are disposed inside the container 100, and its outer surface 330 is on the same plane as the side wall 130 of the container 100. At this time, the volume V1 occupied by the thermo-hygrostat 300 inside the container 100 becomes the minimum converging to 0, the second bracket 310 contacts the first bracket 120, and the distance of the cooling passage d becomes the maximum.

When the reverse rotation of the adjustment bolt 400 moves the thermo-hygrostat 300 inward, the volume V1 occupied by the thermo-hygrostat 300 in the inner space of the container 100 gradually increases, but the volume V2 occupied by the thermo-hygrostat 300 in the outer space of the container 100 decreases. When the thermo-hygrostat 300 maximally enters the inside, the outer surface 330 of the thermo-hygrostat 300 is on the same plane as the side wall 130 of the container 100, and the volume V2 occupied by the thermo-hygrostat 300 outside the container 100 converges to 0. At this time, in order to increase the cooling capacity of the thermo-hygrostat 300, it is preferable to increase the volume so that the cooling passage d, which is a space between the thermo-hygrostat 300 and the battery 200, is formed to a minimum.

Therefore, when the container 100 is transferred, the thermo-hygrostat 300 moves inward the container 100 so that the cooling passage d is minimized, However, when the thermo-hygrostat 300 is operated, the thermo-hygrostat 300 moves outward the container 100 so that the cooling passage d is maximized. Therefore, the cooling passage d is formed longer when operating the thermo-hygrostat 300 than when transporting the container 100.

After moving the thermo-hygrostat 300, in order to fix it to the moved position, a fixture 430 is fitted into the body part 420 of the adjustment bolt 400. The fixture 430 is formed in a cylindrical shape. having a slit 431 through which the body part 420 passes is formed on the side surface, and its center is formed as a hollow, and the body part 420 is inserted.

When the body part 420 is inserted into the hollow center through the slit 431, the fixture 430 is disposed between the first bracket 120 and the second bracket 310, and both ends of the fixture 430 contact the first bracket 120 and the second bracket 310, respectively. Therefore, even if the thermo-hygrostat 300 tries to move in the direction in which the first bracket 120 and the second bracket 310 come closer, the thermo-hygrostat 300 is fixed because the fixture 430 blocks it. Therefore, the movement of the thermo-hygrostat 300 by rotation of the control bolt 400 due to vibration generated in the container 100 or transmitted from the outside is prevented.

When the thermo-hygrostat 300 moves inward and outward, rails (not shown) may be further provided to guide the movement of the thermo-hygrostat 300 having lengths extending inwards and outwards on the bottom or side of the thermo-hygrostat 300. Since the thermo-hygrostat 300 moves along the rail, friction and rolling resistance are reduced, and the thermo-hygrostat 300 can be moved more easily and conveniently.

In the present disclosure, in order to move the thermo-hygrostat 300 in the accommodation opening 110, the adjustment bolt 400 is described as an example, but is not limited thereto. When the rail is formed on the bottom of the thermo-hygrostat 300, the position of the thermo-hygrostat 300 can be controlled by manually pushing or pulling, or by using a leverage-type lever that presses the thermo-hygrostat 300 inward and outward. In order to fix the moved position, various methods other than the fixture 430 may be employed.

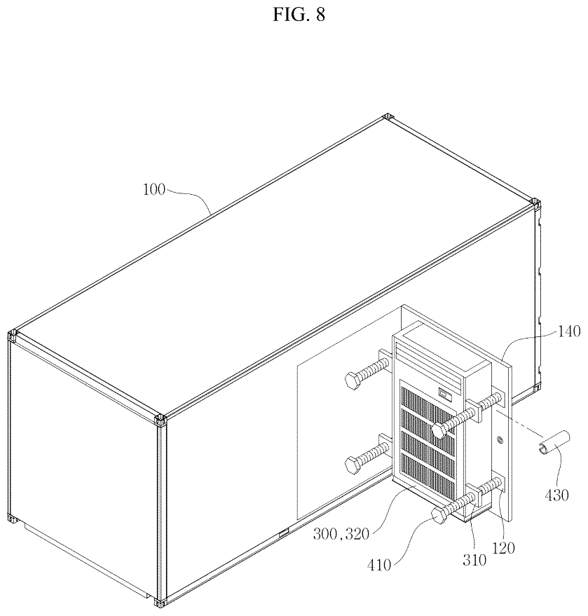

Further, the container 100 according to an embodiment of the present disclosure has an open accommodation opening 110 formed on the side wall 130, and the thermo-hygrostat 300 is inserted into the accommodation opening 110, However, as another embodiment, as shown in FIG. 8, a door 140 capable of opening and closing the inside and outside of the container may be provided, and the thermo-hygrostat 300 may be provided in the door 140.

The accommodation opening 110 is formed in the door 140 so that the thermo-hygrostat 300 may be exposed to the outside of the container 100, and the thermo-hygrostat 300 is inserted therein. Although not shown in the drawing, the packing 111 may be further provided along the edge of the accommodation opening.

The second bracket 310 is provided in the thermo-hygrostat 300, and the first bracket 120 is provided on the door 140 of the container 100, The adjustment bolt 400 passing through the first bracket 120 and the second bracket 310 may move the thermo-hygrostat 300. At this time, the head part 410 of the adjustment bolt 400 is located in the inner direction of the container 100, and the body part 420 may be exposed to the outside of the container 100.

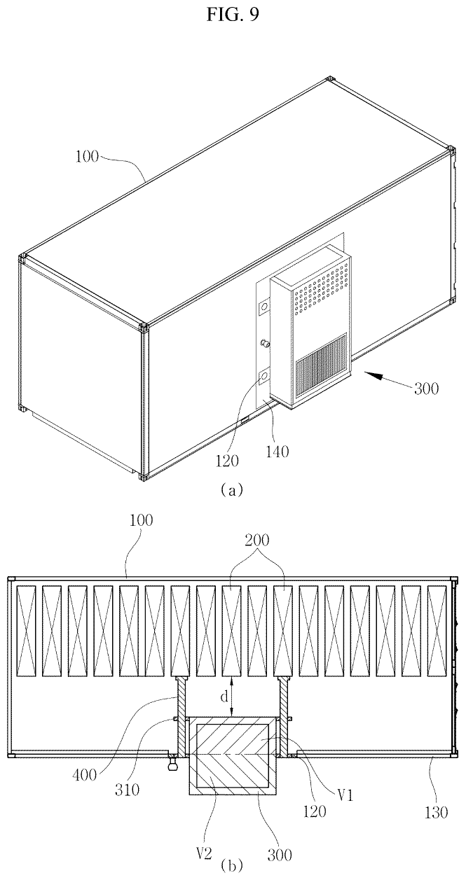

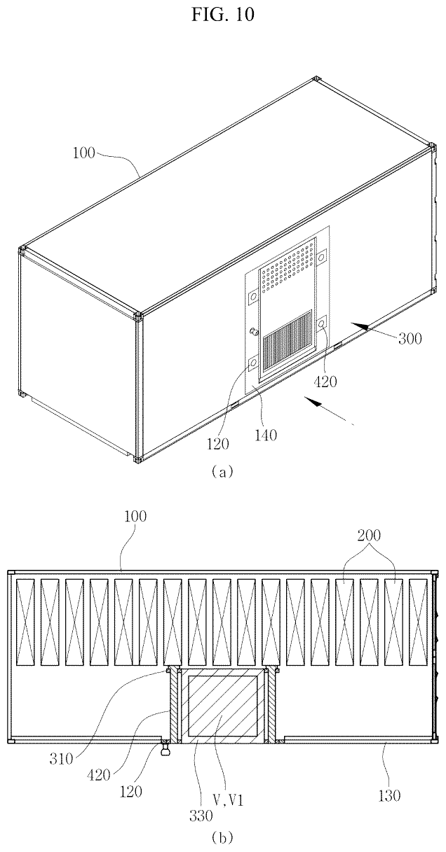

When the door of the container 100 is opened, the thermo-hygrostat 300 also moves along the door 140 as shown in FIG. 8, and when the door is closed, the thermo-hygrostat 300 is positioned as shown in FIGS. 9 and 10. FIG. 9 shows a state in which the thermo-hygrostat 300 is operated in the container 100 equipped with the door 140, and FIG. 10 shows a state in which the container 100 equipped with the door 140 is transported.

The thermo-hygrostat provided in the container for energy storage according to the present disclosure may have a large volume to increase cooling capacity. For example, when the outer surface 330 of the thermo-hygrostat 300 is placed on the same plane as the side wall 130 of the container 100, the inner surface 320 can be formed in a volume very close to that of the battery 200 of the ESS. In this case, the cooling passage d is close to 0, but when starting operation after installing the container 100 for energy storage, the thermo-hygrostat 300 is withdrawn outward to expand the cooling passage d to a space where cold air can sufficiently diffuse, so that it is not necessary to consider the space for the cooling passage d when designing the maximum volume of the thermo-hygrostat 300.

Even if a large amount of heat is generated in the ESS to store and process high-level energy, the volume of the thermo-hygrostat 300 can be increased to reach a target value in response to this.

What is claimed is:

1. A thermo-hygrostat provided in the energy storage container, wherein the thermo-hygrostat stores energy and controls the temperature and humidity of a container in which an energy storage system (ESS) is installed,
wherein an accommodation opening having the size of the thermo-hygrostat is formed on one side of the container in which the ESS is installed,
wherein the thermo-hygrostat is mounted on the accommodation opening so that the outer surface of the thermo-hygrostat is always exposed to the outside of the container, and the thermo-hygrostat slides inside or outside the container through the accommodation opening and the position thereof is varied; and
wherein the position of the thermo-hygrostat during operation protrudes outward of the container more than the position of the thermo-hygrostat during transport of the container.

2. The thermo-hygrostat of claim 1, further comprising: a packing which is provided at an edge of the accommodation opening to contact both side surfaces of the thermo-hygrostat whose position is variably moved and fills a gap between the edge of the accommodation opening and the both side surfaces.

3. The thermo-hygrostat of claim 1, wherein, the thermo-hygrostat is disposed inside the container during transport of the container so that a side wall of the container and an outer surface of the thermo-hygrostat are on the same plane, and the both side surfaces and an inner surface of the thermo-hygrostat are disposed inside the container, and
the thermo-hygrostat moves to the outside of the container during operation so that an outer surface of the thermo-hygrostat protrudes outward from a side wall of the container, thereby widening a cooling passage, which is the space between an inner surface of the thermo-hygrostat and a battery of the ESS disposed inside the container.

4. The thermo-hygrostat of claim 3, comprising:
a first bracket coupled to the side wall of the container and having a first bolt hole formed on one side thereof;
a second bracket coupled to one of both side surfaces of the thermo-hygrostat and having a second bolt hole formed on one side thereof, the second bolt hole facing the first bolt hole; and
an adjustment bolt passing through both the first bolt hole and the second bolt hole, allowing a head part to be in surface contact with the first bracket, and adjusting a distance of the cooling passage while rotating forward and backward.

5. The thermo-hygrostat of claim 4, wherein the thermo-hygrostat is drawn out of the container during forward-rotation of the adjustment bolt so that a volume occupied by the thermo-hygrostat inside the container decreases but a volume occupied by the thermo-hygrostat outside the container increases; and
wherein, when the thermo-hygrostat is maximally drawn out, the second bracket contacts the first bracket, and the volume occupied by the thermo-hygrostat inside the container is minimized to maximize the distance of the cooling passage.

6. The thermo-hygrostat of claim 4, wherein the thermo-hygrostat enters the inside of the container during reverse-rotation of the adjustment bolt so that a volume occupied by the thermo-hygrostat inside the container increases but a volume occupied by the thermo-hygrostat outside the container decreases; and
wherein, when the thermo-hygrostat maximally enters the inside, an outer surface of the thermo-hygrostat and the side wall of the container lie on the same plane, and the volume occupied by the thermo-hygrostat outside the container becomes 0.

7. The thermo-hygrostat of claim 4, further comprising: a fixture formed in a cylindrical shape with a hollow center, having a slit through which the body part of the adjustment bolt passes is formed on the side surface, and having both ends in contact with the first bracket and the second bracket while surrounding the body part of the adjustment bolt.

8. The thermo-hygrostat of claim 4, further comprising: a rail provided on the side or bottom side of the thermo-hygrostat and guiding the movement of the thermo-hygrostat by forward and reverse rotation of the adjustment bolt.

9. The thermo-hygrostat of claim 3, wherein the cooling passage when the thermo-hygrostat is operated is longer than the cooling passage when the container is transferred.
